(19) United States
(12) Patent Application Publication
(10) Pub. No.: US 2008/0048532 A1
(43) Pub. Date: Feb. 28, 2008

(54) Magnetic force sensing device in a brushless motor to enhance magnetic force sensibility of a hall element inside the brushless motor

(75) Inventors: Hsin-Mao Hsieh, Ping Tung City (TW); Hsin-Pu Chen, Taichung City (TW); Wan-Yang Chen, Fongshan City (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: ADDA CORP., Ping Tung City (TW)

(21) Appl. No.: 11/511,101

(22) Filed: Aug. 28, 2006

(51) Int. Cl. H02K 7/00; H02K 11/00; H02K 21/12

(52) U.S. Cl. 310/68 B; 310/67 R; 310/156.05

(57) ABSTRACT

A magnetic force sensing device for a brushless motor includes a drive circuit board mounted inside the casing and located below the stator, a Hall element electrically connected to the drive circuit board, an annular magnet mounted on a rotor casing and located outside the stator, and a magnetic force conducting plate having an area larger than that of the Hall element and being mounted below the drive circuit board to sandwich the Hall element with the annular magnet. Due to the addition of the magnetic force conducting plate below the magnet, magnetic flux from the magnet to the Hall element is increased.

### BACKGROUND OF THE INVENTION

1. Field of the Invention

The present invention relates to a magnetic force sensing device, and more particularly to a magnetic force sensing device in a brushless motor so as to enhance magnetic force sensibility of a Hall element inside the brushless motor.

2. Description of the Prior Art

Inside a brushless motor, there is provided with a drive circuit board, a stator mounted on the drive circuit board and a rotor rotatably mounted outside the stator. The drive circuit board has circuitry formed thereon and a Hall element which is positioned on top of the drive circuit board and electrically connected to the drive circuit board. The stator has a coil which is also electrically connected to the drive circuit board. An annular permanent magnet is mounted inside a circular casing of the rotor and has N-S polarity corresponding to the Hall element on the drive circuit board.

When in application, the Hall element on the drive circuit board is able to sense the polarity of the permanent magnet which corresponds to an induced magnet on the stator such that the Hall element is able to alternately change an induced polarity of the induced magnet to always correspond to the polarity (N-N or S-S) of the permanent magnet while the rotor is rotated. Therefore, the repelling force between two corresponding polarities forces the permanent magnet as well as the rotor which is provided outside the permanent magnet to rotate.

As shown in FIG. 5, it is noted that only the Hall element (71) on top of the drive circuit board (70) functions as the magnetic force sensing agent so as to change the polarity of the magnetic plate of the stator to correspond to the polarity of the permanent magnet. However, due to the distance limitation for magnetic force sensibility of the Hall element and/or strength of the magnetic force from the permanent magnet to the Hall element, the Hall element may not be able to change the induced polarity of the induced magnet in time such that the repelling force between the two corresponding polarities is weak or decreased due to remaining magnetic force between the permanent magnet and the induced magnet of the stator. Accordingly, the efficiency of the motor is damaged.

To overcome the shortcomings, the present invention tends to provide an improved magnetic force sensing device to mitigate the aforementioned problems.

### SUMMARY OF THE INVENTION

The primary objective of the present invention is to provide a magnetic force sensing device to improve the inefficiency of the magnetic force sensibility of the Hall element.

In order to accomplish the aforementioned objective, the magnetic force sensing device includes a drive circuit board, an annular magnet and a magnetic force conducting plate. The drive circuit board is mounted below the stator and has a Hall element electrically connected to the drive circuit board. The annular magnet is mounted on an inner periphery of the motor casing and the magnetic force conducting plate is provided below the drive circuit board to sandwich the Hall element with the annular magnet. Therefore, due to the existence of the magnetic force conducting plate, the magnetic flux from the annular magnet and the Hall element is increased. Consequently, the distance and strength disadvantages of the conventional structure is obviated and the efficiency of the motor is maintained.

Other objects, advantages and novel features of the invention will become more apparent from the following detailed description when taken in conjunction with the accompanying drawings.

### BRIEF DESCRIPTION OF THE DRAWINGS

FIG. 1 is a schematic cross sectional view showing the structure of the magnetic force sensing device of the present invention;

FIG. 2 is an exploded perspective view showing a first embodiment of the magnetic force conducting plate and the drive circuit board;

FIG. 3 is an exploded perspective view showing a second embodiment of the magnetic force conducting plate and the drive circuit board;

FIG. 4 is a schematic side plan view showing the magnetic flux from the permanent magnet to the Hall element as well as the magnetic force conducting plate is increased; and

FIG. 5 is a schematic side plan view showing the magnetic flux from the permanent magnet to the Hall element in a conventional brushless motor structure.

### DETAILED DESCRIPTION OF THE PREFERRED EMBODIMENT

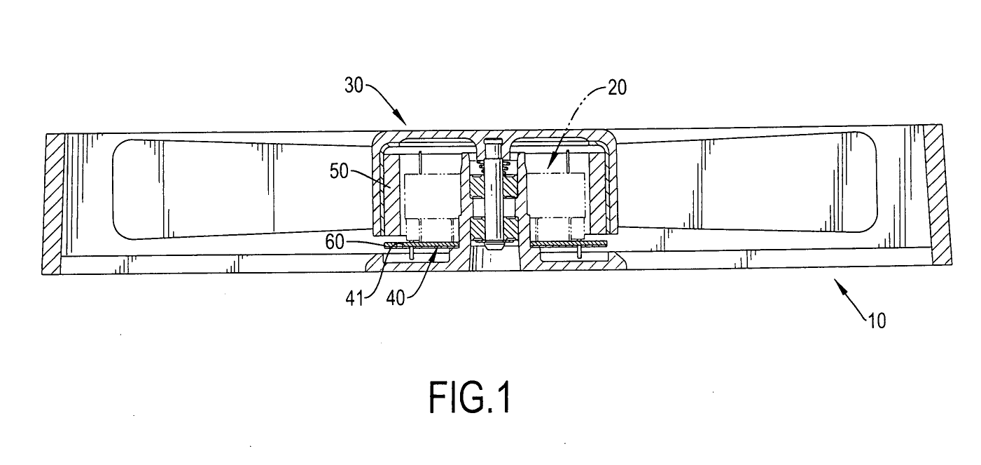

With reference to FIG. 1, it is noted that the magnetic force sensing device in accordance with the present invention is incorporated with a motor having a casing (10), a stator (20) and a rotor (30) both received inside the casing (10). The stator (20) is mounted inside the casing (10) and having therein a coil. The rotor (30) is rotatably mounted inside the casing (10). The magnetic force sensing device includes a drive circuit board (40), a magnet (50) and a magnetic force conducting plate (60).

The drive circuit board (40) is mounted in the casing (10) and has a Hall element (41) electrically connected to the drive circuit board (40) and corresponding to the stator (20).

The magnet (50) is annular and mounted inside a housing of the rotor (30) and outside the stator (20) to keep a distance to an outer periphery of the stator (20). The magnet (50) corresponds to the Hall element (41).

The magnetic force conducting plate (60) is mounted below the drive circuit board (40) to sandwich the Hall element (41) with the magnet (50). The magnetic force conducting plate (60) has an area larger than that of the Hall element (41). Preferably, the magnetic force conducting plate (60) is made of a magnetic force induction material, e.g. metal.

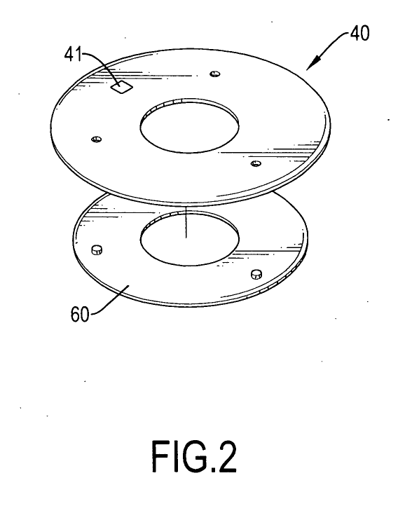

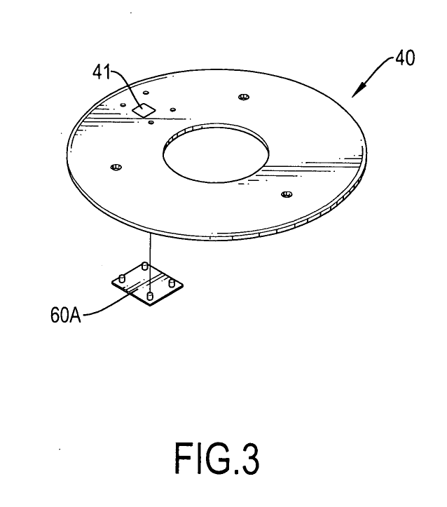

As shown in FIG. 2, it is noted that the magnetic force conducting plate (60) is annular disk and may also be any geometric configuration, such as the rectangular magnetic force conducting plate (60A) shown in FIG. 3.

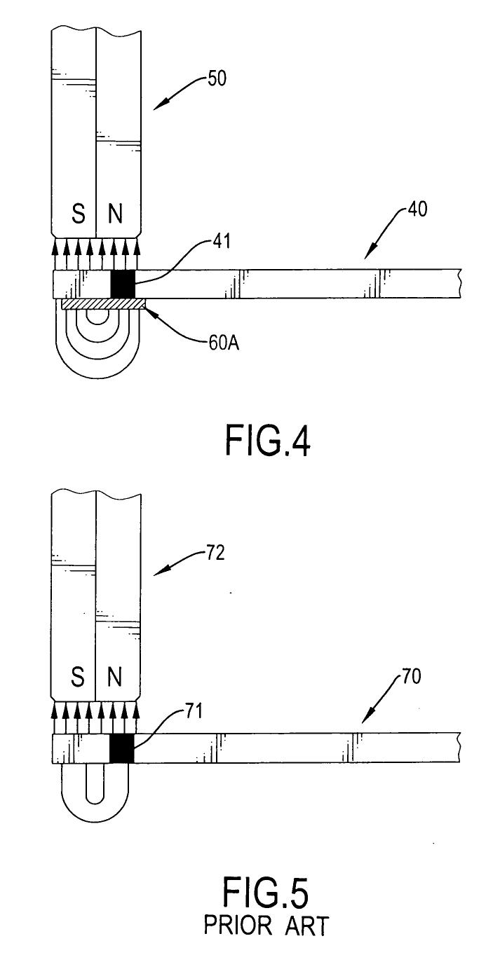

With reference to FIG. 4, it is noted that after the magnetic force sensing device is mounted inside a motor and the drive circuit board (40) is provided with electricity, the Hall element (41) is capable of sensing the polarity of the magnet (50) corresponding to the induced magnet inside the stator (20) so as to alternately change the polarity of the induced magnet of the stator (20) to always correspond to the polarity of the magnet (50) so that the rotor (30) is rotated. Due to the addition of the magnetic force conducting plate (60,60A) below the drive circuit board (40), the magnetic flux from the magnet (50) to the magnetic force conducting plate (60,60A) helps enhance the sensibility of the Hall element (41) to the polarity of the magnet (50). As a consequence of the addition of the magnetic force conducting plate (60,60A), the efficiency of the motor is maintained.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A magnetic force sensing device in a brushless motor having therein a casing, a stator mounted inside the casing and a rotor rotatably mounted inside the casing, the magnetic force sensing device comprising:
a drive circuit board adapted to be mounted inside the casing and located below the stator, the drive circuit board having thereon a Hall element electrically connected to the drive circuit board;
an annular magnet adapted to be mounted on a rotor casing and located outside the stator, the annular magnet corresponding to the Hall element; and
a magnetic force conducting plate having an area larger than that of the Hall element and being mounted below the drive circuit board to sandwich the Hall element with the annular magnet such that magnetic flux from the annular magnet to the Hall element is increased.

2. The magnetic force sensing device as claimed in claim 1, wherein the magnetic force conducting plate is made of a magnetic conducting material.

3. The magnetic force sensing device as claimed in claim 1, wherein the magnetic force conducting plate is an annular disk.

4. The magnetic force sensing device as claimed in claim 2, wherein the magnetic force conducting plate is an annular disk.

5. The magnetic force sensing device as claimed in claim 1, wherein the magnetic force conducting plate is rectangular.

6. The magnetic force sensing device as claimed in claim 2, wherein the magnetic force conducting plate is rectangular.
